(19) United States
(12) Patent Application Publication
(10) Pub. No.: US 2014/0122775 A1
(43) Pub. Date: May 1, 2014

(54) MEMORY CONTROLLER FOR MEMORY DEVICE

(71) Applicant: FREESCALE SEMICONDUCTOR, INC., Austin, TX (US)

(72) Inventors: Nitin Gera, Delhi (IN); Hemant Nautiyal, Greater Noida (IN); Amit Rao, Ghaziabad (IN); Prabhjot Singh, Noida (IN)

(73) Assignee: FREESCALE SEMICONDUCTOR, INC., Austin, TX (US)

(21) Appl. No.: 13/665,906

(22) Filed: Oct. 31, 2012

(51) Int. Cl. G06F 12/02; G06F 12/00

(52) U.S. Cl. 711/103; 711/167; 711/E12.008; 711/211; 711/E12.001

(57) ABSTRACT

A memory controller that generates interface signals for a memory device determines an interface signal frequency based on a timing mode of the memory device and a corresponding clock division ratio. Based on the timing mode, a look up table (LUT) is selected and then a timing parameter corresponding to the clock division ratio and the interface signal frequency is fetched from the LUT. An interface signal is generated based on the interface signal frequency and fetched timing parameter.

### BACKGROUND OF THE INVENTION

The present invention relates generally to memory devices, and, more particularly, to a method and system for generating interface signals for a memory device.

Electronic devices often include a memory device for storing data. Examples of memory devices include NOR and NAND flash memories, double-data rate synchronous dynamic random access memories (DDR-SDRAMs) and hard disk drives (HDDs). A memory controller is connected to the memory device and performs various operations including memory read/write operations on the memory device. Examples of memory controllers include a NOR/NAND flash controller, double data rate (DDR) 1/2/3 controllers and an integrated drive electronics (IDE) controller. The memory controllers communicate with the memory device by way of interface signals. For example, a NAND flash controller communicates with a NAND flash memory using a set of interface signals, defined by the Open NAND Flash Interface (ONFI) Working Group, which include chip enable (CE), address latch enable (ALE), command latch enable (CLE), write enable (WE), read enable (RE), write protected (WP) and DQS, AD [7:0] signals.

The frequency of the interface signals depends on the timing mode of the memory device. The memory device may operate in multiple timing modes for which the memory controller is required to generate interface signals with multiple frequencies. The number of timing modes depends on the type of memory device and is often specified by the manufacturer. For example, a NAND flash memory may operate in six timing modes (ranging from 20 MHz to 100 MHz), for which the NAND flash controller generates six interface signals (having six different frequencies).

Further each timing mode has multiple timing parameters associated with it. For example, in a memory device having six timing modes and 10 timing parameters corresponding to each timing mode, 60 timing parameters need to be manually calculated and programmed by the user. The timing parameters define various attributes of an interface signal and include delay parameters associated with exchange of messages between the memory device and the memory controller, type of data being exchanged and type of operation being performed on the memory device. Examples of timing parameters associated with interface signals for NAND flash memories include address-command, command address delay (tCADf, tCADs), setup time (tADVS) and ADV hold time (tADVH) values.

Based on the timing mode of the memory device, corresponding interface signal frequency and timing parameters are calculated. Currently, for each timing mode, the timing parameters are manually calculated and programmed by the user. Hence, a change in the timing mode requires newly calculating and programming the timing parameters into the memory controller, which is a time consuming and error prone task and requires multiple programming cycles of timing registers within the memory controller.

Therefore, it would be advantageous to have a system for generating interface signals for a memory controller that dynamically and automatically calculates timing parameters across different timing modes, that reduces the time required for generating interface signals, and that overcomes the above mentioned disadvantages of existing memory controllers.

### BRIEF DESCRIPTION OF THE DRAWINGS

The following detailed description of the preferred embodiments of the present invention will be better understood when read in conjunction with the appended drawings. The present invention is illustrated by way of example, and not limited by the accompanying figures, in which like references indicate similar elements.

FIG. 1 is a schematic block diagram of a memory controller generating an interface signal for a memory device in accordance with an embodiment of the present invention; and

FIG. 2 is a flow chart depicting a method for generating an interface signal by a memory controller for a memory device in accordance with an embodiment of the present invention.

### DETAILED DESCRIPTION OF THE INVENTION

The detailed description of the appended drawings is intended as a description of the currently preferred embodiments of the present invention, and is not intended to represent the only form in which the present invention may be practiced. It is to be understood that the same or equivalent functions may be accomplished by different embodiments that are intended to be encompassed within the spirit and scope of the present invention. As used herein, the term multiplexer has been abbreviated as a mux.

In an embodiment of the present invention, a method for generating an interface signal by a memory controller for a memory device is provided. An interface signal frequency is determined based on a timing mode of the memory device and corresponding clock division ratio value stored in the memory controller. A first look-up table (LUT) is selected from a plurality of LUTs stored in the memory controller, based on the timing mode. Each LUT stores a mapping between a clock division ratio value, corresponding interface signal frequency and a plurality of timing parameters associated with the interface signal frequency. At least one timing parameter is fetched from the first LUT. The interface signal is generated, based on the interface signal frequency and the at least one timing parameter.

In another embodiment of the present invention, a memory controller for generating an interface signal for a memory device is provided. The memory controller includes a control register that stores a plurality of timing modes of the memory device and corresponding plurality of clock division ratio values. A plurality of look up tables (LUTs) are connected to the control register Each LUT stores a mapping between a clock division ratio value, corresponding interface signal frequency and a plurality of timing parameters associated with the interface signal frequency. A plurality of input terminals of a multiplexer are connected to corresponding plurality of LUTs and a select terminal of the multiplexer is connected to the control register for receiving a control signal corresponding to the timing mode. The multiplexer selects a first LUT of the plurality of LUTs, based on the control signal and outputs at least one timing parameter from the first LUT. A timing register is connected to an output terminal of the multiplexer and receives and stores the at least one timing parameter. A clock control module is connected to the control register and generates an interface signal frequency value by dividing a system clock frequency by the clock division ratio value corresponding to the timing mode. An interface timing controller is connected to the clock control module and the timing register, for receiving the interface signal frequency value and the at least one timing parameter, respectively. The interface timing controller initiates the generation of the interface signal. An interface signal generator is connected to the interface timing controller, for generating the interface signal.

Various embodiments of the present invention provide a system and method for generating interface signals for a memory device. A memory controller is connected to the memory device and generates interface signals for performing read/write operations on the memory device. The memory controller generates interface signals having different frequencies corresponding to different timing modes of the memory device. Timing parameters for each timing mode are programmed in to look-up tables (LUTs) of the memory controller. Based on the timing mode of the memory device, a corresponding LUT is selected and timing parameters from the LUT are loaded in to timing registers of the memory controller. These timing parameters are then used to generate an interface signal. Thus, the timing parameters are automatically loaded from respective LUTs when the timing mode of the memory device is changed, as opposed to existing systems which require manual programming of the timing parameters into the memory controller for each change in timing mode. Thus, the time required for generating the interface signals is greatly reduced.

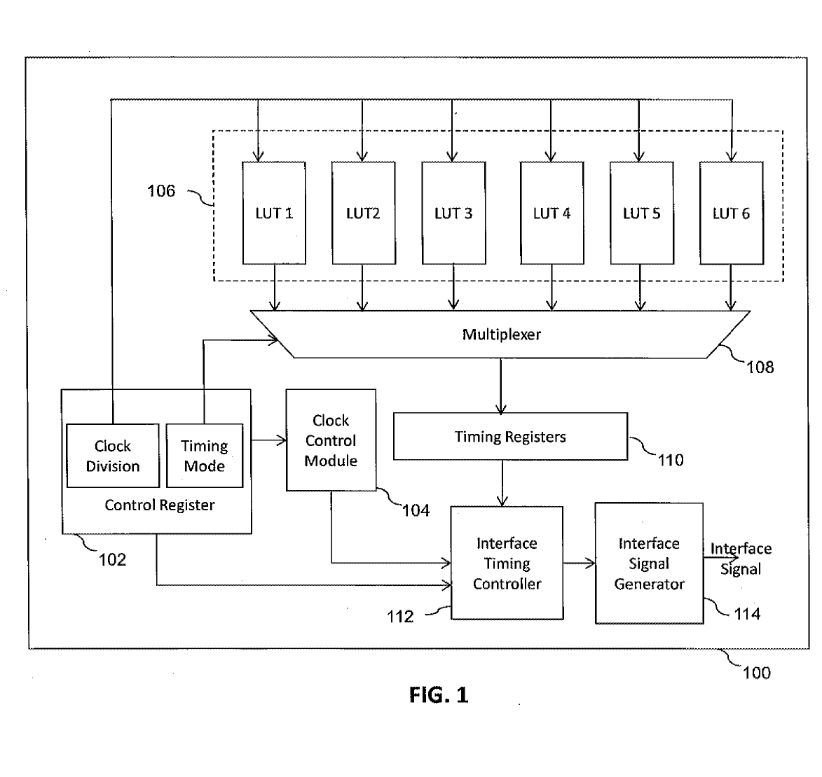

Referring now to FIG. 1, a schematic diagram illustrating a memory controller 100 for generating an interface signal for a memory device, is shown. The memory controller 100 includes a control register 102, a clock control module 104, a plurality of look up tables (LUTs) including first through six LUTs 106a-106f (hereinafter collectively referred to as LUTs 106), a mux 108, a plurality of timing registers 110, an interface timing controller 112, and an interface signal generator 114. Examples of memory devices include NOR and NAND flash memories, double-data rate synchronous dynamic random access memories (DDR-SDRAM), and hard disk drives (HDDs). Examples of memory controllers 110 include NAND and NOR flash controllers, double data-rate (DDR1/DDR2/DDR3) controllers and an integrated drive electronics (IDE) controller.

The memory controller 100 communicates with the memory device (not shown) by way of interface signals. The frequency of the interface signals (referred to as interface signal frequency) differs based on the timing mode in which the memory device operates. For example, a NAND flash memory controller and a DDR1 controller each may generate six interface signals having six different frequencies corresponding to six timing modes of a NAND flash memory and a DDR1 memory, respectively. Similarly, a NOR flash controller generates two interface signals having two different frequencies corresponding to two timing modes of a NOR flash memory. The timing modes and corresponding interface signal frequencies for NAND flash, DDR1 and NOR flash controllers have been illustrated in table A.

TABLE A
Timing modes for different memory controllers

| | | |
|---|---|---|
| NAND Flash | DDR1 | NOR Flash |
| Controller | Controller | Controller |

| Timing | Freq. | Timing | Freq. | Timing | Freq. |
|---|---|---|---|---|---|
| Mode | (MHz) | Mode | (MHz) | Mode | (MHz) |
| 1 | 20 | PC1600 | 100 | 0 | 54 |
| 2 | 33 | PC2100 | 133 | 1 | 66 |
| 3 | 50 | PC2400 | 150 | | |
| 4 | 66 | PC2700 | 166 | | |
| 5 | 83 | PC3000 | 183 | | |
| 6 | 100 | PC3200 | 200 | | |

The control register 102 stores the timing modes and clock division ratio values corresponding to the different timing modes. Clock division ratio value is the ratio of a system clock frequency and an interface signal frequency. In various embodiments of the present invention, the system clock frequency refers to the frequency of a global clock signal used in a system-on-chip (SoC), in which the memory controller 100 and the memory device may be integrated. The control register 102 may include programmable registers (not shown) for storing the timing modes and the clock division ratio values.

The LUTs 106 are connected to the control register 102. Each LUT 106 stores a map between a clock division ratio value, corresponding interface signal frequency, and timing parameters corresponding to the interface signal frequency. The timing parameters define various attributes of an interface signal and include delay parameters associated with exchange of messages between the memory device and the memory controller, type of data being exchanged and type of operation being performed on the memory device. An exemplary list of timing parameters corresponding to NAND flash, DDR1 and NOR flash controllers has been provided in table B.

TABLE B
Timing parameters

| Memory | |
|---|---|
| Controller | List of Timing Parameters |
| NAND Flash | an address-command, command address delay (tCADf, |
| Controller | tCADs), a data output end to write/read (W/R) # |
| | high (tCKWR), an access window of DQS from CLK |
| | (tDQSD), a W/R# low to DQS/DQ driven by device |
| | (tDQSCK), a W/R# high to DQS/DQ tri-state by |
| | device (tDQSHZ), a data output cycle to command, |
| | an address, or data input cycle (tRHW), a ready |
| | to data output cycle (tRR), a CLK rising edge to |
| | SR[6] low (tWB), a command, address or data input |
| | cycle to data output cycle (tWHR), a DQS write |
| | preamble (tWPRE), a DQS write postamble (tWPST), |
| | a W/R# low to data output cycle (tWRCK), and a |
| | WP# transition to command cycle (tWW) |
| DDR1 | active to precharge command (tRAS), ACTIVE to |
| Controller | ACTIVE/AUTO REFRESH command period (tRC), AUTO |
| | REFRESH command period (tRFC), ACTIVE to READ or |
| | WRITE delay (tRCD), PRECHARGE command period |
| | (tRP), ACTIVE bank a to ACTIVE bank b command |
| | (tRRD), Write recovery time (tWR), REFRESH to |
| | REFRESH command interval (tREFC), Access window |
| | of DQS from CK/CK# (tDQSCK), Write command to |
| | first DQS latching transition (tDQSS) |
| NOR Flash | ADV Setup Time (tADVS), ADV Hold Time (tADVH), CS |
| Controller | Setup Time to Clock Rising (tCSS), CS Low Hold |
| | Time from Clock (tCSLH), CS High Pulse Width |
| | (tCSHP), ADV High Pulse Width (tADHP), Chip |
| | Select to WAIT Low (tWL), ADV Falling to WAIT Low |
| | (tAWL), Clock to WAIT High (tWH), Chip De-select |
| | to WAIT High-Z (tWZ), Output Enable to Low-Z |
| | Output (tOLZ), Latency Clock Rising Edge to Data |
| | Output (tCD), Output Hold (tOH), Burst End Clock |
| | to Output High-Z (tHZ), Chip De-select to Output |
| | High-Z (tCHZ), Output Disable to Output High-Z |
| | (tOHZ), UB, LB Disable to Output High-Z (tBHZ), WE |
| | Set-up Time to Command Clock (tWES), WE Hold Time |
| | from Command Clock (tWEH), WE High Pulse Width |
| | (tWHP), Data Set-up Time to Clock (tDS), Data |
| | Hold Time from Clock (tDHC) |

The LUTs 106 may be stored in a memory or a storage register (not shown) of the memory controller 100. For example, a NAND flash controller has six LUTs (first through six LUTs 106a-106f), corresponding to the six timing modes and stores values of the corresponding timing parameters, as illustrated in table C.

TABLE C
Exemplary implementation of LUTs 106 in a NAND Flash
Controller

| | | Interface | | |
|---|---|---|---|---|
| | Timing | Signal | | tCAS values |
| LUT | Mode | Frequency (MHz) | tCS values (ns) | (ns) |
| 106a | 1 | 20 | 35 | 10 |
| 106b | 2 | 33 | 25 | 5 |
| 106c | 3 | 50 | 15 | 4 |
| 106d | 4 | 66 | 15 | 3 |
| 106e | 5 | 83 | 15 | 2.5 |
| 106f | 6 | 100 | 15 | 2 |

Input terminals of the mux 108 are connected to the LUTs 106 and a select terminal of the mux 108 is connected to the control register 102. Based on the timing mode in which the memory device operates, the mux 108 receives a select signal from the control register 102 and selects a corresponding LUT 106. The clock division ratio values are used to select one or more timing parameters from the selected LUT 106. The timing parameters stored in the selected LUT 106 are output at the output terminal of the mux 108. The timing registers 110 are connected to the output terminal of the mux 108 and receive and store the timing parameters corresponding to different timing modes.

The clock control module 104 is connected between the control register 102 and the interface timing controller 112. Based on the timing mode of the memory controller 100, the clock control module 104 divides the system clock frequency by the corresponding clock division ratio value to derive the interface signal frequency value. The interface timing controller 112 is connected to the control register 102, the timing registers 110 and the clock control module 104 and receives the clock division ratio value and timing mode information, timing parameters and the interface signal frequency value therefrom, respectively. The interface signal generator 114 is connected to the interface timing controller 112 and receives an indication therefrom to generate the interface signal using the interface signal frequency value and the timing parameters.

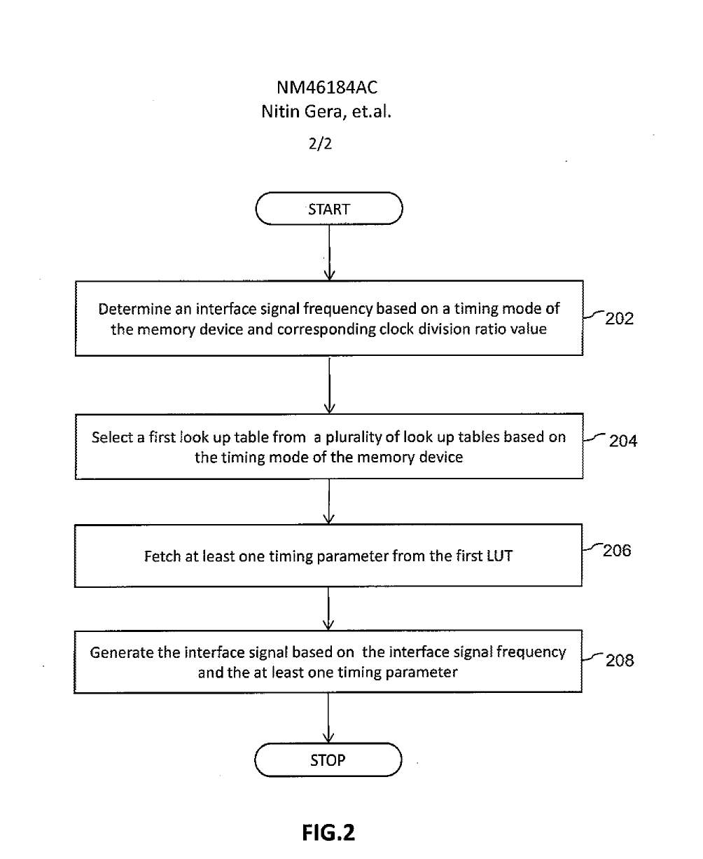

Referring now to FIG. 2, a flowchart depicting a method for generating an interface signal for a memory device by a memory controller 100 is shown. Steps of the flowchart of FIG. 2 have been explained in conjunction with FIG. 1.

At step 202, an interface signal frequency is determined based on a timing mode of the memory device and the corresponding clock division ratio value stored in the control register 102. The interface signal frequency is the frequency at which the memory controller 100 communicates with the memory device and changes based on a timing mode in which the memory device operates. The clock division ratio value is the ratio of a system clock frequency to the interface signal frequency. At step 204, a first look up table (LUT) 106 is selected from a plurality of LUTs (106a-106f), based on the timing mode of the memory device. Each LUT 106 stores a mapping between a clock division ratio value, corresponding interface signal frequency and a plurality of timing parameters associated with the interface signal frequency. At step 206, at least one timing parameter is fetched from the first LUT 106. The at least one timing parameter is stored in the timing register 110. At step 208, the interface signal is generated based on the interface signal frequency and the at least one timing parameter by the interface signal generator 114.

While various embodiments of the present invention have been illustrated and described, it will be clear that the present invention is not limited to these embodiments only. Numerous modifications, changes, variations, substitutions, and equivalents will be apparent to those skilled in the art, without departing from the spirit and scope of the present invention, as described in the claims.

1. A method for generating an interface signal for a memory device by a memory controller, comprising:
determining an interface signal frequency based on a timing mode of the memory device and corresponding clock division ratio value stored in the memory controller;
selecting a first look-up table (LUT) from a plurality of LUTs stored in the memory controller, based on the timing mode, wherein each LUT stores a mapping between a clock division ratio value and corresponding interface signal frequency and a plurality of timing parameters associated with the interface signal frequency;
fetching at least one timing parameter from the first LUT; and
generating the interface signal based on the interface signal frequency and the at least one timing parameter.

2. The method of claim 1, wherein the plurality of timing parameters includes at least one of an address-command, command address delay (tCADf, tCADs), a data output end to write/read (W/R)# high (tCKWR), an access window of DQS from CLK (tDQSD), a W/R# low to DQS/DQ driven by device (tDQSCK), a W/R# high to DQS/DQ tri-state by device (tDQSHZ), a data output cycle to command, an address or data input cycle (tRHW), a ready to data output cycle (tRR), a CLK rising edge to SR[6] low (tWB), a command, address or data input cycle to data output cycle (tWHR), a DQS write preamble (tWPRE), a DQS write postamble (tWPST), a W/R# low to data output cycle (tWRCK), and a WP# transition to command cycle (tWW), active to precharge command (tRAS), ACTIVE to ACTIVE/AUTO REFRESH command period (tRC), AUTO REFRESH command period (tRFC), ACTIVE to READ or WRITE delay (tRCD), PRECHARGE command period (tRP), ACTIVE bank a to ACTIVE bank b command (tRRD), Write recovery time (tWR), REFRESH to REFRESH command interval (tREFC), Access window of DQS from CK/CK# (tDQSCK), Write command to first DQS latching transition (tDQSS), ADV Setup Time (tADVS), ADV Hold Time (tADVH), CS Setup Time to Clock Rising (tCSS), CS Low Hold Time from Clock (tCSLH), CS High Pulse Width (tCSHP), ADV High Pulse Width (tADHP), Chip Select to WAIT Low (tWL), ADV Falling to WAIT Low (tAWL), Clock to WAIT High (tWH), Chip De-select to WAIT High-Z (tWZ), Output Enable to Low-Z Output (tOLZ), Latency Clock Rising Edge to Data Output (tCD), Output Hold (tOH), Burst End Clock to Output High-Z (tHZ), Chip De-select to Output High-Z (tCHZ), Output Disable to Output High-Z (tOHZ), UB, LB Disable to Output High-Z (tBHZ), WE Set-up Time to Command Clock (tWES), WE Hold Time from Command Clock (tWEH), WE High Pulse Width (tWHP), Data Set-up Time to Clock (tDS), and Data Hold Time from Clock (tDHC).

3. The method of claim 1, wherein the interface signal includes at least one of a chip enable (CE) signal, a command latch enable (CLE) signal, an address latch enable (ALE) signal, a memory clock signal (CLK), a read/write ready (R/W) signal, a data qualifier strobe (DQS) signal, and a data (DQ) signal.

4. The method of claim 1, wherein the memory device comprises at least one of a NAND flash memory, a NOR flash memory, a hard disk drive (HDD), and a double data rate synchronous dynamic random access memory (DDR-SDRAM).

5. The method of claim 1, wherein the memory controller comprises at least one of a NAND flash controller, a NOR flash controller, an integrated drive electronics (IDE) controller, a double data rate (DDR) 1 controller, a DDR 2 controller, and a DDR 3 controller.

6. The method of claim 1, wherein the clock division ratio value corresponds to a ratio of a system clock frequency to the interface signal frequency.

7. A memory controller for generating an interface signal for communicating with a memory device, comprising:
a control register for storing a plurality of timing modes of the memory device and a corresponding plurality of clock division ratio values;
a plurality of look up tables (LUTs) connected to the control register, wherein each LUT stores a mapping between a clock division ratio value and corresponding interface signal frequency and a plurality of timing parameters associated with the interface signal frequency;
a multiplexer having a plurality of input terminals connected to a corresponding plurality of the LUTs and a select terminal connected to the control register for receiving a control signal corresponding to the timing mode, wherein the multiplexer selects a first LUT of the plurality of LUTs based on the control signal and outputs at least one timing parameter from the first LUT;
a timing register, connected to an output terminal of the multiplexer, for receiving and storing the at least one timing parameter;
a clock control module, connected to the control register, for generating an interface signal frequency value by dividing a system clock frequency by the clock division ratio value corresponding to the timing mode;
an interface timing controller, connected to the clock control module and the timing register, for receiving the interface signal frequency value and the at least one timing parameter, respectively, and initiating generation of the interface signal; and
an interface signal generator, connected to the interface timing controller, for generating the interface signal.

8. The memory controller of claim 7, wherein the plurality of timing parameters includes at least one of an address-command, command address delay (tCADf, tCADs), a data output end to write/read (W/R)# high (tCKWR), an access window of DQS from CLK (tDQSD), a W/R# low to DQS/DQ driven by device (tDQSCK), a W/R# high to DQS/DQ tri-state by device (tDQSHZ), a data output cycle to command, an address or data input cycle (tRHW), a ready to data output cycle (tRR), a CLK rising edge to SR[6] low (tWB), a command, address or data input cycle to data output cycle (tWHR), a DQS write preamble (tWPRE), a DQS write postamble (tWPST), a W/R# low to data output cycle (tWRCK), and a WP# transition to command cycle (tWW), active to precharge command (tRAS), ACTIVE to ACTIVE/AUTO REFRESH command period (tRC), AUTO REFRESH command period (tRFC), ACTIVE to READ or WRITE delay (tRCD), PRECHARGE command period (tRP), ACTIVE bank a to ACTIVE bank b command (tRRD), Write recovery time (tWR), REFRESH to REFRESH command interval (tREFC), Access window of DQS from CK/CK# (tDQSCK), Write command to first DQS latching transition (tDQSS), ADV Setup Time (tADVS), ADV Hold Time (tADVH), CS Setup Time to Clock Rising (tCSS), CS Low Hold Time from Clock (tCSLH), CS High Pulse Width (tCSHP), ADV High Pulse Width (tADHP), Chip Select to WAIT Low (tWL), ADV Falling to WAIT Low (tAWL), Clock to WAIT High (tWH), Chip De-select to WAIT High-Z (tWZ), Output Enable to Low-Z Output (tOLZ), Latency Clock Rising Edge to Data Output (tCD), Output Hold (tOH), Burst End Clock to Output High-Z (tHZ), Chip De-select to Output High-Z (tCHZ), Output Disable to Output High-Z (tOHZ), UB, LB Disable to Output High-Z (tBHZ), WE Set-up Time to Command Clock (tWES), WE Hold Time from Command Clock (tWEH), WE High Pulse Width (tWHP), Data Set-up Time to Clock (tDS), and Data Hold Time from Clock (tDHC).

9. The memory controller of claim 7, wherein the interface signal includes at least one of a chip enable (CE) signal, a command latch enable (CLE) signal, an address latch enable (ALE) signal, a memory clock signal, a read/write ready (R/W) signal, a data qualifier strobe (DQS) signal, and a data (DQ) signal.

10. The memory controller of claim 7, wherein the memory device comprises at least one of a NAND flash memory, a NOR flash memory, a hard disk drive (HDD), and a double data rate synchronous dynamic random access memory (DDR-SDRAM).

11. The memory controller of claim 7, wherein the memory controller comprises at least one of a NAND flash controller, a NOR flash controller, an integrated drive electronics (IDE) controller, a double data rate (DDR) 1 controller, a DDR 2 controller and a DDR 3 controller.

12. The memory controller of claim 7, wherein the clock division ratio value corresponds to a ratio of a system clock frequency to the interface signal frequency.

13. A tangible computer readable medium having a software program including executable instructions that cause a memory controller to generate an interface signal for a memory device, the software program comprising:
determining an interface signal frequency based on a timing mode of the memory device and corresponding clock division ratio value stored in the memory controller;
selecting a first look-up table (LUT) from a plurality of LUTs stored in the memory controller, based on the timing mode, wherein each LUT stores a mapping between a clock division ratio value and corresponding interface signal frequency and a plurality of timing parameters associated with the interface signal frequency;
fetching at least one timing parameter from the first LUT; and
generating the interface signal, based on the interface signal frequency and the at least one timing parameter.

14. The tangible computer readable medium of claim 13, wherein the plurality of timing parameters includes at least one of an address-command, command address delay (tCADf, tCADs), a data output end to write/read (W/R)# high (tCKWR), an access window of DQS from CLK (tDQSD), a W/R# low to DQS/DQ driven by device (tDQSCK), a W/R# high to DQS/DQ tri-state by device (tDQSHZ), a data output cycle to command, an address or data input cycle (tRHW), a ready to data output cycle (tRR), a CLK rising edge to SR[6] low (tWB), a command, address or data input cycle to data output cycle (tWHR), a DQS write preamble (tWPRE), a DQS write postamble (tWPST), a W/R# low to data output cycle (tWRCK), and a WP# transition to command cycle (tWW), active to precharge command (tRAS), ACTIVE to ACTIVE/AUTO REFRESH command period (tRC), AUTO REFRESH command period (tRFC), ACTIVE to READ or WRITE delay (tRCD), PRECHARGE command period (tRP), ACTIVE bank a to ACTIVE bank b command (tRRD), Write recovery time (tWR), REFRESH to REFRESH command interval (tREFC), Access window of DQS from CK/CK# (tDQSCK), Write command to first DQS latching transition (tDQSS), ADV Setup Time (tADVS), ADV Hold Time (tADVH), CS Setup Time to Clock Rising (tCSS), CS Low Hold Time from Clock (tCSLH), CS High Pulse Width (tCSHP), ADV High Pulse Width (tADHP), Chip Select to WAIT Low (tWL), ADV Falling to WAIT Low (tAWL), Clock to WAIT High (tWH), Chip De-select to WAIT High-Z (tWZ), Output Enable to Low-Z Output (tOLZ), Latency Clock Rising Edge to Data Output (tCD), Output Hold (tOH), Burst End Clock to Output High-Z (tHZ), Chip De-select to Output High-Z (tCHZ), Output Disable to Output High-Z (tOHZ), UB, LB Disable to Output High-Z (tBHZ), WE Set-up Time to Command Clock (tWES), WE Hold Time from Command Clock (tWEH), WE High Pulse Width (tWHP), Data Set-up Time to Clock (tDS), and Data Hold Time from Clock (tDHC).

15. The tangible computer readable medium of claim 13, wherein the interface signal includes at least one of a chip enable (CE) signal, a command latch enable (CLE) signal, an address latch enable (ALE) signal, a memory clock signal, a read/write ready (R/W) signal, a data qualifier strobe (DQS) signal, and a data (DQ) signal.

16. The tangible computer readable medium of claim 13, wherein the memory device comprises at least one of a NAND flash memory, a NOR flash memory, a hard disk drive (HDD), and a double data rate synchronous dynamic random access memory (DDR-SDRAM).

17. The tangible computer readable medium of claim 13, wherein the memory controller comprises at least one of a NAND flash controller, a synchronous NOR flash controller, an integrated drive electronics (IDE) controller, a double data rate (DDR) 1 controller, a DDR 2 controller, and a DDR 3 controller.

18. The tangible computer readable medium of claim 13, wherein the clock division ratio value corresponds to a ratio of a system clock frequency to the interface signal frequency.
